(19) United States
(12) Patent Application Publication
(10) Pub. No.: US 2019/0371175 A1
(43) Pub. Date: Dec. 5, 2019

(54) SERVER, METHOD, AND COMPUTER-READABLE STORAGE MEDIUM FOR AUTOMATED PARKING

(71) Applicant: Valeo Schalter und Sensoren GmbH, Bietigheim-Bissingen (DE)

(72) Inventors: Malte JOOS, Stuttgart (DE); Steve KREYER, Stuttgart (DE); Mohammad POORSARTEP, Birmingham, MI (US); Mahmoud SHALABY, Bietigheim-Bissingen (DE)

(73) Assignee: Valeo Schalter und Sensoren GmbH, Bietigheim-Bissingen (DE)

(21) Appl. No.: 16/428,804

(22) Filed: May 31, 2019

Related U.S. Application Data
(60) Provisional application No. 62/680,519, filed on Jun. 4, 2018.

(51) Int. Cl. G08G 1/14; G06F 16/29; B60W 30/06; H04W 4/40; H04W 4/38

(52) U.S. Cl. CPC G08G 1/14; G06F 16/29; B60W 30/06; B60W 2420/54; H04W 4/38; B60W 2420/52; B60W 2420/42; H04W 4/40

(57) ABSTRACT

The present disclosure relates to a server, method, and non-transitory computer-readable storage medium for automated parking. According to an embodiment, the above-described server, method, and computer-readable storage medium of the present disclosure generally relate to receiving a parking request from a mobile device associated with a vehicle, receiving sensor data from one or more sensors of the vehicle, generating a fusion map based at least on the sensor data, from the one or more sensors, detecting one or more parking spaces within a pre-defined distance from the vehicle based on the fusion map, receiving, from the mobile device, a selection of one of the detected parking spaces in response to sending information corresponding to the detected parking spaces to the mobile device, generating a parking trajectory corresponding to the selected parking space, and transmitting, to the vehicle, the parking trajectory, the transmission enabling an automated parking procedure by the vehicle.

### CROSS-REFERENCE TO RELATED APPLICATIONS

The present application claims priority to U.S. Provisional Application No. 62/680,519, filed Jun. 4, 2018, the teaching of which is hereby incorporated by reference in its entirety for all purposes.

### BACKGROUND

### Field of the Disclosure

The present disclosure relates to vehicle automated parking procedures and methods thereof.

### Description of the Related Art

Current solutions for automated parking employ in-vehicle electronic control units to process inputs from sensors of the vehicle and perform automated parking on the basis thereof. The processing power necessary to permit automated parking can include analyzing sensor data, determining parking space geometry, plotting a parking trajectory, selecting a parking trajectory, and executing the parking trajectory. Considered alone or in view of tasks being performed concurrently by an in-vehicle electrical control unit, these processes often create substantial computational burdens and, ultimately, limit the variety of features that may be offered during automated parking and the like. Moreover, such processing requires specific electronic control units be installed within each vehicle.

Accordingly, there is a need in the art for a solution providing automated parking to vehicles without the computational burden of traditional approaches.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present invention.

### SUMMARY

The present disclosure relates to a server, method, and non-transitory computer-readable storage medium for cloud-driven parking assistance.

According to an embodiment, the above-described server, method, and computer-readable storage medium of the present disclosure generally relate to receiving a parking request from a mobile device associated with a vehicle, receiving sensor data from one or more sensors of the vehicle, generating a fusion map based at least on the sensor data from the one or more sensors, detecting one or more parking spaces within a pre-defined distance from the vehicle based on the fusion map, receiving, from the mobile device, a selection of one of the detected parking spaces in response to sending information corresponding to the detected parking spaces to the mobile device, generating a parking trajectory corresponding to the selected parking space, and transmitting, to the vehicle, the parking trajectory, the transmission enabling an automated parking procedure by the vehicle.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram of a cloud-driven automated parking system, according to an exemplary embodiment of the present disclosure;

FIG. 2A is a flow diagram of a cloud-driven automated parking system, according to an exemplary embodiment of the present disclosure;

FIG. 2B is a flow diagram of an aspect of a cloud-driven automated parking system, according to an exemplary embodiment of the present disclosure;

FIG. 3 is a schematic of one or more sensors of a vehicle, according to an exemplary embodiment of the present disclosure;

FIG. 4 is a block diagram of a cloud-driven automated parking system, according to an exemplary embodiment of the present disclosure;

FIG. 5A is a flow diagram of fusion map generation in a cloud-driven automated parking system, according to an exemplary embodiment of the present disclosure;

FIG. 5B is a flow diagram of sensor data processing in a cloud-driven automated parking system, according to an exemplary embodiment of the present disclosure;

FIG. 5C is a flow diagram of parking space detection in a cloud-driven automated parking system, according, to an exemplary embodiment of the present disclosure;

FIG. 5D is a flow diagram of parking trajectory generation in a cloud-driven automated parking system, according to an exemplary embodiment of the present disclosure

FIG. 6 is a flow diagram of emergency braking system integration in a cloud-driven automated parking system, according to an exemplary embodiment of the present disclosure;

FIG. 7 is an illustration of security features of a cloud-driven automated parking system, according to an exemplary embodiment of the present disclosure;

FIG. 8 is a schematic illustrating the communication architecture of a global system for a cloud-driven automated parking system, according to an exemplary embodiment of the present disclosure; and

FIG. 9 is a block diagram of a vehicle electronics control system, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used, herein, is defined as at least a second or more. The terms “including” and/or “having”, as used herein, are defined as comprising (i.e., open language). The terms “obstacle” and “impediment” may be used interchangeably, as appropriate, throughout this application. Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Some portions of this description describe the embodiments of the disclosure in terms of algorithms and operations. These operations are understood to be implemented by computer programs or equivalent electrical circuits, machine code, or the like. Furthermore, it has also proven convenient at times, to refer to these arrangements of operations as modules or units, without loss of generality. The described operations and their associated modules or units may be embodied in software, firmware, and/or hardware.

Steps, operations, or processes described may be performed or implemented with one or more hardware or software modules, alone or in combination with other devices. Although the steps, operations, or processes are described in sequence, it will be understood that in some embodiments the sequence order may differ from that which has been described, for example with certain steps, operations, or processes being omitted or performed in parallel or concurrently.

It is nearly-ubiquitous for modern vehicles to be outfitted with a variety of sensors. Whether internal or external to the passenger cabin of the vehicle, these sensors provide the foundation for driving automation and vehicle autonomy.

The degree to which data from these sensors can be processed and used for automated driving, however, is dependent upon the processing power and capacity of an onboard computer or electronics control unit.

In the case of Level 1 or Level 2 driving automation, vehicle sensors can be used for driver assistance, providing such features as ‘Adaptive Cruise Control’ and ‘Lane Keeping Assistance’. However, the driver is still required to be alert and maintain control of the vehicle for the duration of the assisted-driving maneuver or procedure.

Level 3 and Level 4 driving automation provide increased autonomy to the vehicle. Vehicle sensors can be used to monitor the surrounding environment and to control the vehicle. For example, the vehicle can be capable of autonomous operation in controlled environments and can perform tasks including parking and emergency braking without driver interference. Such integration of vehicle sensor data and vehicle processing power promises to usher in fully automated, steering wheel optional, Level 5 automated driving.

Of course, achieving higher levels of vehicle autonomy often necessitates a higher financial burden to the driver, as the complex algorithms and software required to complete such advanced tasks require specially-programmed processing circuitry and electronics control units that, inherently, drive the cost of ownership of the vehicle higher.

Few, however, have considered the possibility of providing aspects of higher levels of vehicle autonomy without the need for highly-advanced on-board computers, instead utilizing a cloud-driven system, including a server, and exploiting data transmitted from vehicle sensors. Autonomous features that provide improved comfort and safety can then be implemented within a vehicle that, otherwise, would not be able to perform such functions. In this way, drivers may “opt-in” only when desired in order to enjoy features of automated driving, such as automated parking, without the attendant, often exorbitant, ownership costs. Moreover, this approach removes limitations previously placed upon algorithms performed by in-vehicle electronics control units, as the resources and processing power of a ‘cloud-based’ server allow for the execution of more advanced algorithms.

In view of the above and according to an embodiment, the present disclosure relates to a cloud-driven automated parking system, including a server, that receives data from sensors on board a vehicle, analyzes the data, determines parking space geometry, plots a parking trajectory to a selected parking space, receives instructions indicating, for instance, parking space selection and vehicle orientation, and then transmits instructions to the vehicle to execute the parking procedure.

Accordingly, the present disclosure relates to a system, including a server, and corresponding methods for providing cloud-driven automated parking to one or more vehicles.

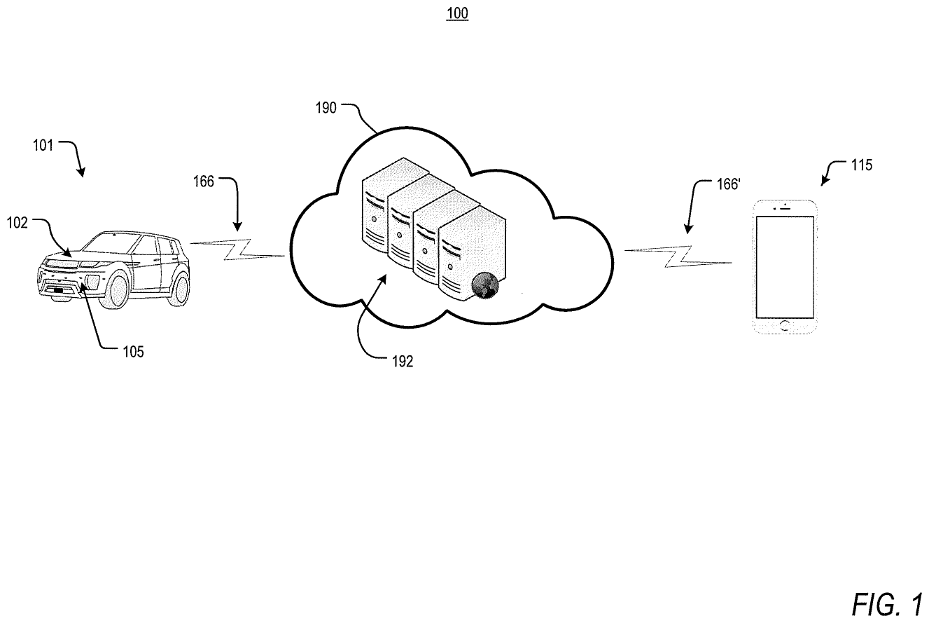

With reference now to the Figures, FIG. 1 is a diagram of a cloud-driven automated parking system (CDAPS) 100. When considered in the context of a driver “opting-in” to the CDAPS 100, the CDAPS 100 can be considered as a Parking as a Service system. The CDAPS 100 includes, at least, (1) a parking controller residing on a vehicle (e.g., a vehicle electronics control unit (VECU) 102), (2) a server 192, or parking sever 192, that resides in a cloud-computing environment 190, and (3) a mobile device 115 (e.g., smartphone, tablet, and the like) that is either inside the vehicle 101 or in close proximity of the vehicle 101. Unlike previous approaches, the present disclosure allows for the separation of the processing circuitry that executes the complex parking algorithms from the VECU 102 located on the vehicle 101. Moreover, the present disclosure removes the direct connection between the mobile device 115 and the vehicle 101, enhancing stability and universality of the approach.

To this end, the VECU 102 and the mobile device 115 may communicate, via parallel communication paths, with the parking server 192 via wireless communication links 166, 166′.

In an embodiment, the vehicle 101 can be equipped with one or more sensors 105, enabling sensing of the vehicle environment, the one or more sensors 105 including ultrasonic sensor(s), radar sensor(s), odometric sensor(s), laser scanner(s), camera(s), and the like. In an embodiment, the camera(s) can be a plurality of cameras positioned around the vehicle 101 and can be configured to provide a surround-view of the vehicle 101.

In an example, data from the one or more sensors 105 can be received by the VECU 102 and transmitted to the parking server 192. In an example, data from the one or more sensors 105 of the vehicle 101 can be pre-processed. Accordingly, the VECU 102 may then transmit some or all of the received data from the one or more sensors 105 to the parking server 192 of the cloud-based computing environment 190 using the wireless communication link 166.

According to an embodiment, the parking server 192 of the cloud-computing environment 190 may communicate with the mobile device 115 via wireless communication link 166′. The mobile device 115 may be a smartphone or tablet device of a driver of the vehicle 101 and the wireless communication link 166′ may provide access to the parking server 192 of the cloud-computing environment 190 via Internet-based domain, or web address. In an example, the web address can be a web address specifically assigned to the driver of the vehicle such that, when attempting to control a parking procedure of the vehicle, permissions can be confirmed such that ownership and control of the vehicle is established.

In an embodiment, the connectivity between the mobile device 115 (e.g., occupant of the vehicle 101 requesting the vehicle 101 to be parked) and the vehicle 101 can be performed via the parking server 192, wherein each of the mobile device 115 and the vehicle 101 can connect with the parking server 192 of the cloud-computing environment 190. The approach of the present disclosure offers the opportunity to have a tablet, computer, or any other device capable of accessing the web address to be utilized as the mobile device 115 in order to initiate the parking procedure, or parking service. In general, using a web address to communicate between the mobile device 115 and the parking server 192 of the cloud-computing environment 190 eliminates the need for a native software application on the mobile device 115 or for regular updates to the software application on the mobile device 115. Moreover, using a web-address to communicate between the mobile device 115 and the parking server 192 eliminates the need to pair the mobile device 115 with the vehicle 101 using a short range communication method, such as Bluetooth and the like. Instead, all updates can be made to a single web address and accessed by all end users, making the updates available across platforms. The human machine interface of the web address can be designed to convey as much information as desired since it is no longer limited to the data bandwidth of the connectivity solutions currently available between the mobile device 115 and the vehicle 101 (e.g., Bluetooth). This information can range from live video feed to more visualized vehicle parking trajectory, payment and transaction solutions, and the like.

According to an embodiment, the VECU 102 may transmit sensor data to the parking server 192 of the cloud-computing environment 190 only upon receiving a request for automated parking. The request may be initiated by a driver of the vehicle 101, for instance, when the driver is ready to park the vehicle 101. The request may be indicated to the parking server 192 via depression of a button on the vehicle 101, interaction with a user interface of the vehicle 193, or any other mechanism in the vehicle 101 to initiate an automated parking handshake and process. For instance, the request may be initiated via the mobile device 115. Alternatively, the VECU 102 may transmit sensor data to the parking server 192 of the cloud-computing environment 190 at regular intervals independent of driver interaction with the vehicle 101 indicating a request

According to an embodiment, after receipt of a parking request, the parking server 192 may begin receiving sensor data from the vehicle 101 via the VECU 102. Upon transmittance, via the wireless communication link 166, received sensor data may be used to generate a fusion map reflecting received sensor data in view of a tracked position of the vehicle 101. During an automated parking procedure, the parking server 192 may then perform parking space detection. Responsive to an indication from the mobile device 115 that a driver selects a specific one of the detected parking spaces, the parking server 192 determines a corresponding parking trajectory for performing the parking procedure for the designated parking space and transmits the instruction to the VECU 102 for execution. Updates to the parking trajectory can be performed in real-time upon receipt of updated sensor data from the VECU 102.

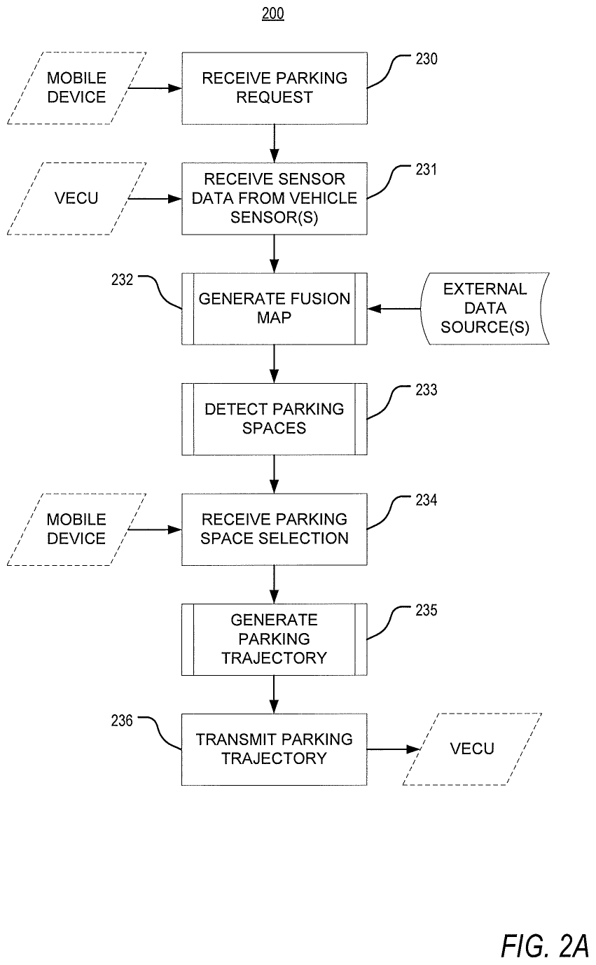

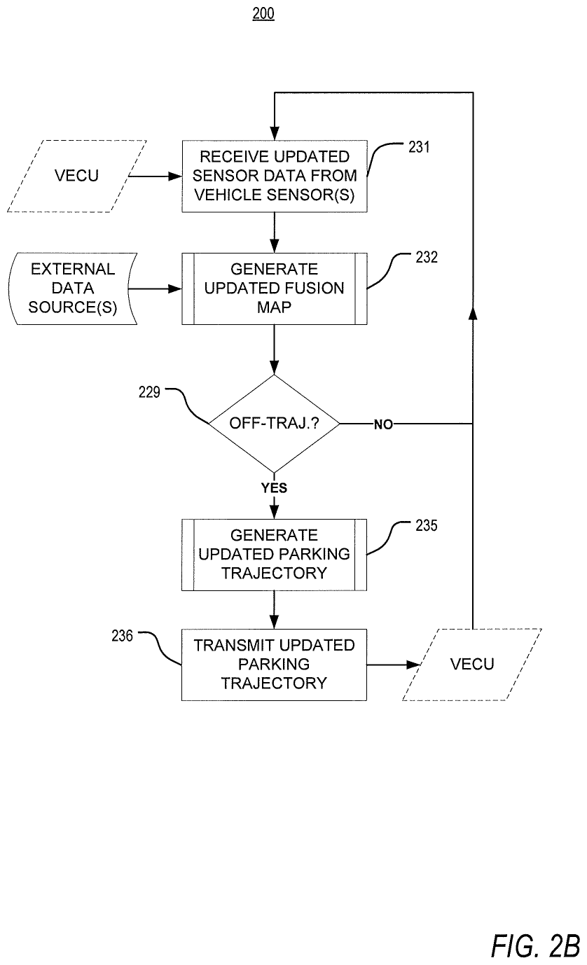

The CDAPS 100 introduced, generally, above will now be described in more detail with reference to FIG. 2A and FIG. 2B.

FIG. 2A is a flow diagram of a process 200 of a CDAPS, according to an exemplary embodiment of the present disclosure. Each sub process introduced below will be described in greater detail in subsequent Figures.

At step 230 of process 200, a parking request is received by a parking server. In an embodiment, the parking request is generated by a mobile device. Alternatively, the parking request can be automatically generated when vehicle speed, as determined from one or more sensors, is below a pre-determined threshold typically indicative of a desire to perform a parking procedure.

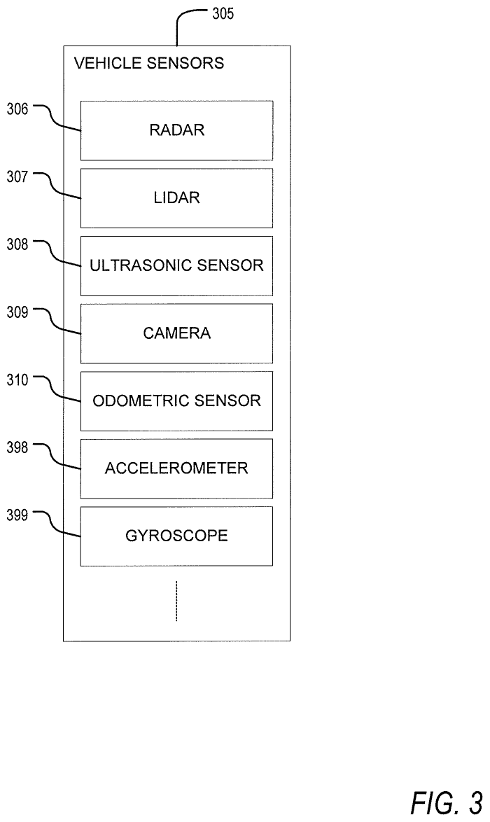

At step 231 of process 200, and responsive to receiving the parking request at step 230, sensor data is received from one or more sensors of a vehicle via a VECU. In an embodiment, and with reference to FIG. 3, the one or more sensors 305 can include at least one of radar 306, Light Detection and Ranging (LiDAR) 307, ultrasonic sensor 308, camera 309, odometric sensor 310, including wheel pulse sensors and wheel orientation sensors, accelerometer 398, gyroscope 399, or a combination thereof. The wheel pulse sensors and wheel orientation sensors can provide for estimation of relative position of the vehicle in space.

During operation, as described with respect to FIG. 2A and FIG. 2B, the one or more sensors 305 may include, at a minimum, distancing sensors such as radar 306, lidar 307, an ultrasonic sensor 308, an odometric sensor 310, or a combination thereof.

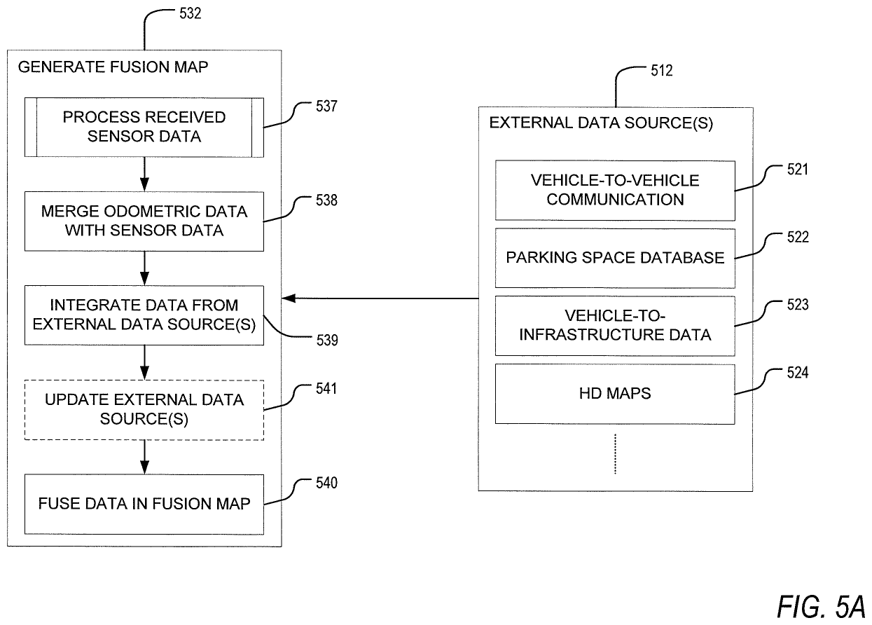

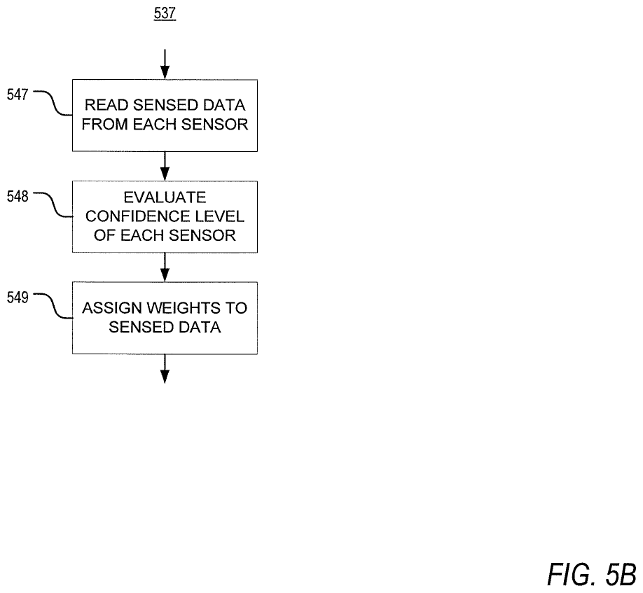

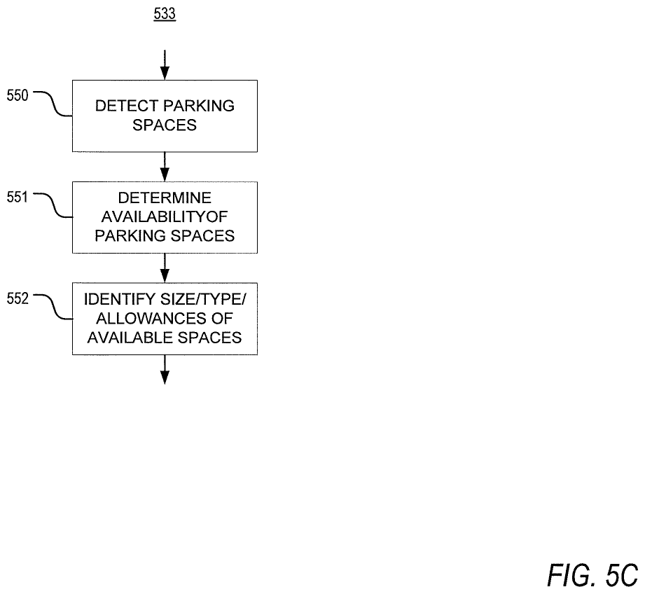

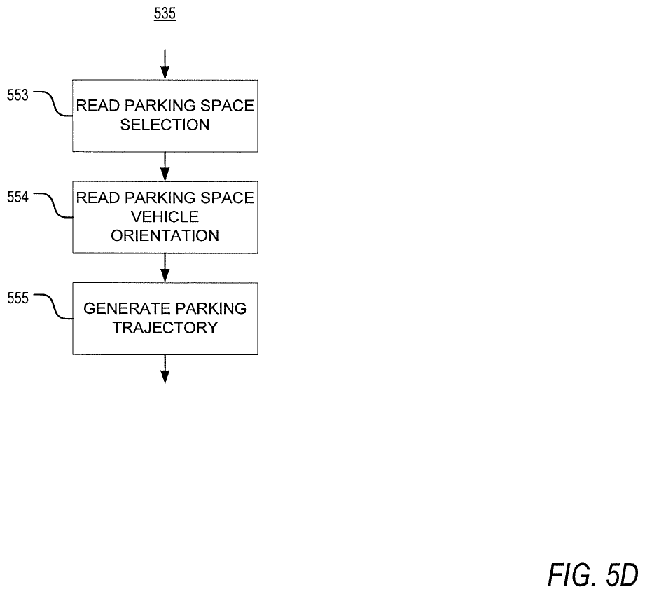

Returning to FIG. 2A, a fusion map can be generated by the parking server at sub process 232 of process 200. The fusion map can be generated by combining sensor data received from the one or more sensors, at step 231 with data from external data sources. The sensor data received from the one or more sensors at step 231 includes odometric sensor data which can be processed to determine vehicle positioning data (i.e. tracked position). For instance, the fusion map may reflect a combination of distancing data from an ultrasonic sensor and an image acquired at the same point in time by a camera, the combination of these data being fused with positioning data and compared to previously acquired maps of the external environment to determine the vehicle environment. Accordingly, the data from external data sources can include, for example, data from prior vehicle trips, high definition (HD) maps, and third-party vendors, and will be described in more detail with respect to FIG. 5A.

In an embodiment, the odometric sensor-based vehicle positioning data can be supplemented by vehicle positioning data acquired from a Satellite Positioning System such as a Global Navigation Satellite System.

At sub process 233 of process 200 the fusion map generated at sub process 232 is processed by the parking server to detect parking spaces. The detected parking spaces can be evaluated to determine geometry (e.g., Is my vehicle too large for the parking space?), availability permissions (e.g., Is the parking space reserved for a handicapped driver?), costs, and the like, in order to request, from the mobile device, a selection as to which parking space is desirable.

Accordingly, at step 234 of process 200, a parking space selection, from the mobile device, can be received at the parking server.

Based upon the parking space selection received at step 234, the parking server can generate a corresponding parking trajectory at sub process 235 of process 200. In generating the corresponding parking trajectory, the parking server considers an indication from the mobile device as to the parking orientation of the vehicle (perpendicular, parallel).

Having generated the corresponding parking trajectory for the selected parking space at sub process 235, the parking server transmits the parking trajectory to the VECU at step 236 of process 200. The VECU can then control execution of the parking trajectory to complete the parking procedure.

As described above, when the parking trajectory generated by the parking server is received by the vehicle via the VECU, an automated parking process is initiated to park the vehicle at the selected parking space based on the generated parking trajectory. It can be appreciated that, however accurate an initially-generated parking trajectory may be, the external environment of a vehicle may change in real-time and the initially-generated parking trajectory may no longer achieve the target. Accordingly, updated sensor data can be continuously transmitted from the VECU to parking server, ensuring that changes in the external environment, and thus updates to the parking trajectory, can be realized as needed in real-time.

FIG. 2B is a flow diagram reflecting real-time updates to the parking trajectory. As before, at step 231 of process 200, sensor data is received by the parking server from one or more sensors of the vehicle via the VECU. In an embodiment, and with reference to FIG. 3, this updated sensor data can be received from one or more sensors 305 including at least one of radar 306, lidar 307, ultrasonic sensor 308, camera 309, accelerometer 398, gyroscope 399, or a combination thereof.

Returning to FIG. 2B, an updated fusion map can be generated by the parking server at sub process 232 of process 200. The updated fusion map can be generated by combining the updated sensor data received from the one or more sensors at step 231 with data from external data sources and current positioning data (e.g., odometric sensor data and Global Navigation Satellite System data). For instance, as it relates to data updated during a parking procedure, the updated fusion map may reflect a combination of current distancing data acquired by an ultrasonic sensor, an image acquired by a camera at the same point in time, and vehicle positioning data. By comparison with a previously generated fusion map and with previously acquired maps of the external environment at step 229 of process 200, it may be indicated that a current parking trajectory, as reflected by a real-time position of a vehicle relative to the selected parking space, will not achieve a successful parking procedure. Generally speaking, step 229 of process 200 describes a comparison of a current value of the vehicle to a pre-determined value, threshold, or range, and a corrective action based thereon. In practical use, this comparison may include a calculation of a delta value indicating a value difference between a current vehicle position and an anticipated vehicle position at the same time relative to the selected parking space. In addition, the comparison may include comparing curves of a current trajectory with curves of predicted, successful trajectory based on updated data. This comparison may also include, in an example, an evaluation of sensor data from an accelerometer and/or a gyroscope to provide a predictive aspect to where the vehicle is expected to move in a subsequent move.

If it is determined, in an example, that the current vehicle position is acceptable and, therefore, a future vehicle position is expected to accomplish a successful parking procedure, the process 200 may return to step 231 and updated sensor data may again be received from the VECU at the parking server. If, however, it is determined at step 229 that the current position of the vehicle and/or an anticipated future position of the vehicle will not accomplish a successful parking procedure, the process 200 proceeds to sub process 235 and similar to before, an updated parking trajectory of the vehicle can be generated.

Once generated at step 235 of process 200, the updated parking trajectory can be transmitted to the VECU at step 236 and the parking procedure can continue. As before, continuously updated sensor data can be received by the parking server at step 231 and the parking trajectory can be updated, as needed.

In one embodiment, the generated parking trajectory can be transmitted to the VECU in relatively small data packets that can be easily handled by cellular network bandwidth and latency.

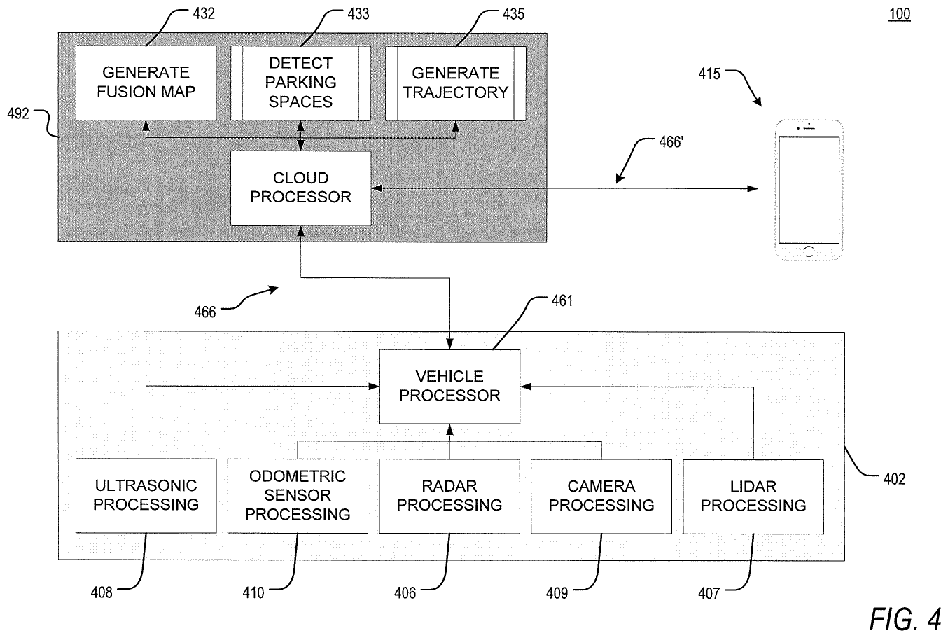

FIG. 4 is a low-level block diagram of the CDAPS 100, according to an exemplary embodiment of the present disclosure. It should be noted that different processing blocks and/or modules may be added or deleted from this example, without departing from the teachings of the present disclosure. As illustrated, a parking server 492, including a ‘cloud processor’, is configured to receive sensor data from a VECU 402 and may include modules for performing each of the tasks of FIG. 2A and FIG. 2B. For example, the modules may be configured to generate a map 432, detect a parking space 433, generate a vehicle parking trajectory 444, and communicate, in parallel, with the VECU 402 of a vehicle and a mobile device 415. As described with respect to FIG. 1, in an embodiment, two parallel connections 466, 466′ exist: (1) between the VECU 402 of the vehicle and the parking server 492, and (2) between the mobile device and the parking server 492. In an embodiment, the VECU 402 of the vehicle may be in communication with one or more sensors disposed within and/or on the vehicle. The one or more sensors correspond to processing units and include, at least, ultrasonic processing 408, odometric sensor processing 410, radar processing 406, camera processing 409, and lidar processing 407. Each of the sensor processing units may be connected to a vehicle processor 461 of the VECU 402 and may be configured to communicate with the parking server 492 through a telematics unit (e.g., vehicle connectivity gateway) of the VECU 402.

In view of the flow diagrams of FIG. 2A and FIG. 2B, FIG. 5A through FIG. 5D provide flow diagrams of sub processes therein.

FIG. 5A provides a flow diagram of a fusion map generation sub process, according to an exemplary embodiment of the present disclosure.

At sub process 537 of sub process 532, sensor data received from one or more sensors of the vehicle undergoes processing at the parking server. The sensor data, generally, may include odometric data (e.g., wheel pulse sensor data, wheel orientation sensor data) along with data from one or more cameras, ultrasonic sensors, radars, LiDARs, or any combination thereof. In an embodiment, and as will be described later, the received sensor data can be used to generate a fusion map of immediate surroundings of the vehicle.

The processing of sub process 537 of sub process 532 can include evaluating confidence levels of the acquired sensor data. The processing can include determining if sensor data from each and every one of the one or more sensors needs to be processed. For instance, if a current sensor data value of one of the one or more sensors does not change over time, then the previous sensor data value can be used and the current sensor data value does not need to be processed, thereby alleviating processing circuitry of the parking server of this computational burden. Moreover, as described in more detail with reference to FIG. 5B, the processing can include adjusting the impact of sensor data on a final result according to confidence levels of each of the one or more sensors.

Having performed initial processing on the received sensor data from the one or more sensors at sub process 537, the processed sensor data may be merged with the odometric sensor data at step 538 of sub process 532, allowing for generation of a fusion map.

In an embodiment, the odometric sensor data may be supplemented by Satellite Positioning System data, such as Global Navigation Satellite System data, that can provide accurate and precise location data of the vehicle such that the vehicle can be tracked in real-time. In this way, processed sensor data can be synced with the location of the vehicle for generation of a global fusion map of the environment of the vehicle. It can be appreciated, however, that the Satellite Positioning System data is merely supplementary and, therefore, the CDAPS is readily performed according to only the odometric sensor data-based merged sensor data.

Next, at step 539 of sub process 532, the merged sensor data from step 538 can be evaluated in the context of data received from external data sources 512. Such external data sources 512 can include data gathered from nearby vehicles via vehicle-to-vehicle communication 521, data from the parking server of the cloud-computing environment providing information on a parking environment as acquired by previous vehicles 522, data determined by local, state, and national government authorities and/or by parking structure planners indicating parking space size, permissions, and availability (i.e. vehicle-to-infrastructure data 523), HD maps generated by. For instance, third party navigation software applications 524, and the like. For each instance of external data 512, data received therefrom can be used to improve accuracy of the merged sensor data of step 536 and/or to update the external data source 512, as in step 541 of sub process 532.

With regards to vehicle-to-vehicle communication 521, other vehicles within range of a host vehicle may be considered as support vehicles and may transmit information to the host vehicle currently seeking a parking space via the CDAPS. In this case, the support vehicles may not have used the CDAPS but may nonetheless include one or more sensors actively acquiring sensor data similar to that described in the present disclosure. Data from the support vehicles may be selected to be received by the parking server if the support vehicles are within a pre-defined radius of the vehicle or, for instance, are co-located with the host vehicle within a parking structure. Further, data from the support vehicles may be selected to be received by the parking server based on the time history of the available data, considering that only most recent data may benefit the host vehicle. These controls allow for the parking server to increase speed of processing upon receipt of the data.

With reference to the parking space database 522, these data can include previously generated fusion maps from prior trips of the host vehicle or from trips of other vehicles that have traversed the same space via the CDAPS. Accordingly, the parking server cart access, within the parking space database 522 of the parking server, data describing the vehicle environment as it was previously experienced. This can, for instance, provide complete insight as to a parking structure even when a host vehicle has just entered the parking structure.

Vehicle-to-infrastructure data 523 can include data describing a physical arrangement of a parking structure and can include data from sensors outfitted within the parking structure. Vehicle-to-infrastructure data 523 can be passed to the parking server via the VECU, wherein, for instance, an RFID reader of the VECU of the vehicle is brought in proximity of an RFID tag of the parking structure. The RFID tag, or radio-frequency identification tag, may communicate information including the architectural plans of the parking structure, the number and size of parking spaces, and the permissions of those parking spaces. It can be appreciated that the RFID system described above could be replaced with any technique for co-locating a vehicle within a parking structure, including using positioning data, image processing of signage, and the like. Vehicle-to-infrastructure data 523 may also include parking structure sensors that evaluate the presence of other vehicles within the garage and within parking spaces therein. For instance, individual parking spaces may include infrared cameras and or magnetic field systems to detect the presence of a vehicle within an individual parking space. The indication can be included within the generated fusion map to indicate parking spaces that may or may not be available.

In certain cases, third party vendors such as navigational map developers may have generated highly detailed HD maps 524 of the parking structure. In such a case, information from the HD map 524 can be used to provide information on the parking structure, writ large, and to improve accuracy of the merged sensor data.

Upon evaluation of the merged sensor data with external data sources 512 at step 539, the external data sources 512 can be updated as needed, at step 541. Alternatively, if the external data sources 512 do not need to be updated, sub process 532 can proceed to step 540 and generation of the fusion map.

In an embodiment, the merged sensor data can be used to confirm the quality of present sensor data in view of data from the external data source 512. For instance, it may be that the present sensor data was acquired with high confidence and there is a positive correlation (i.e., a difference between corresponding values is within an acceptable range), above a pre-determined threshold, between the merged sensor data and the data from the external data source. In such a case, the external data source 512 does not need to be updated but for updating a time stamp. In another instance, it may be that the present sensor data was acquired with low confidence and there is a negative correlation, below a pre-determined threshold, between the merged sensor data and the data from the external data source. Accordingly, data from the external data source 512 can be used at step 539, to improve the accuracy of the merged sensor data. Similarly to the above, only the time stamp of the external data source 512 need be updated. In another instance, however, it may be that the present sensor data was acquired with high confidence but there remains a negative correlation, below the pre-determined threshold, between the merged sensor data and the data from the external data source. Accordingly, the merged sensor data may be considered more accurate and the external data source 512 may need to be updated to match. This may occur when a physical object in a parking structure has moved or, simply, when vehicles are no longer resident in parking spaces.

Upon update of the external data sources 512 at step 541, the resulting data can be fused in generation of a fusion map at step 540 of sub process 532. The generated fusion map, therefore, reflects the merged sensor data in view of external data sources 512, providing an accurate map for the parking procedure.

As described with reference to FIG. 5A, and with reference to the flow diagram of FIG. 5B, sub process 537 allows for evaluation and integration of sensor data confidence levels, according to an embodiment of the present disclosure. In this way, received sensor data with high confidence levels can be given increased weight during fusion map generation and, similarly, received sensor data with low confidence levels can be all but ignored.

For instance, at step 547 of sub process 537, received sensor data from each of the one or more sensors of the vehicle can be read at the parking server. As sensor data from each of the one or more sensors of the vehicle will include a corresponding confidence level of the sensor data (i.e., is the sensor data accurate?) each of the one or more sensors can be evaluated, at step 548 of sub process 537, to determine what weight should be given to the sensor data acquired therefrom. For instance, the weight can be a value from 0 to 1. When a confidence level of an ultrasonic sensor, for example, is below a pre-determined threshold, the sensor data acquired therefrom can be assigned a weight of 0 or close thereto. Similarly, if a confidence level of radar, for example, is above a pre-determined threshold, the sensor data acquired therefrom can be assigned a weight of 1. Of course, if a confidence level of a particular sensor is of moderate value, a weight between 0 and 1 would be appropriate. It can be appreciated that other scales and mechanisms can be implemented while keeping with the spirit of the invention such that processed sensor data reflects the most accurate representation of the quality of the underlying data.

Accordingly, at step 549 of sub process 537, weights can be assigned to the sensor data and, ultimately, a generated fusion map will reflect the quality of the data from each of the sensors.

In view, again, of FIG. 5A, FIG. 5C provides a flow diagram of sub process 533. Specifically, FIG. 5C describes parking space detection following generation of the fusion map.

At step 550 of sub process 533, the generated fusion map can be evaluated in order to detect parking spaces. Evaluation of the generated fusion map includes, for instance, identification of vehicles, parking space demarcations such as lines and curbs, parking structure signage and parking space signage, and the like.

At step 551 of sub process 533, the detected parking spaces can be analyzed to determine availability. For instance, though a parking space may have been detected, it may also be true that a vehicle is currently parked in the detected parking space. Accordingly, this parking space should not be considered as a possible available parking space for a current vehicle.

Having determined the available parking spaces at step 551, each of the available spaces can be further evaluated at step 552 of sub process 533. Specifically, the available parking spaces can be evaluated in context of previously determined data, including parking space demarcations and signage. This evaluation can determine a ‘fit’ of a vehicle within the available parking space, the ‘fit’ of the vehicle reflecting the size of the current vehicle relative to the size of the available spot, the type of vehicle spot (e.g., electric vehicle only?), the permissions needed (e.g., law enforcement only?), and the like. Such aspects as the size of the vehicle and the type of the vehicle can be associated with the vehicle and or the user account and known readily. Similarly, the permissions of the driver or a passenger of the vehicle may be readily known if associated with a mobile device, however, in an embodiment, the parking server may be configured to request any exceptions to the permissions as input via the mobile device.

Therefore, following step 552, only available parking spaces that ‘fit’ the current vehicle will be presented for selection via mobile device. In an example, a current vehicle has initiated an automated parking procedure via the CDAPS and has entered a parking structure. Having generated the fusion map and determined availability of parking spaces, the parking server identifies that, out of ten available sparking spaces, six of them ‘fit’ the current vehicle, as one of the parking spaces is too small (the current vehicle is a large truck), two of the parking spaces are for electric vehicles only, and one of the parking spaces is designated for government officials only. Accordingly, the mobile device is presented, for selection, with the six parking spaces that available and a ‘fit’ for the current vehicle.

In an embodiment, the selection can be provided by a user via the mobile device.

Having been presented with parking spaces that are available and a ‘fit’, the parking server generates a parking trajectory corresponding to a selected parking space at sub process 535.

With reference to the flow diagram of FIG. 5D, first, the parking server reads the parking space selection at step 553 of sub process 535. The parking space selection includes the position of the parking space but can also include vehicle orientation information, which can be read at step 554 of sub process 535. In an embodiment, and in an event that multiple vehicles are associated with a mobile device, the parking server may request a vehicle selection from the mobile device. In an example, the vehicle orientation information may indicate interest in having the vehicle parked forward, backward, or parallel.

Accordingly, at step 555 of sub process 535, a corresponding parking trajectory that, at least initially, achieves the selected parking space, can be generated. The corresponding parking trajectory can be transmitted to the VECU of the vehicle and the parking procedure can proceed as described with respect to FIG. 2A and FIG. 2B.

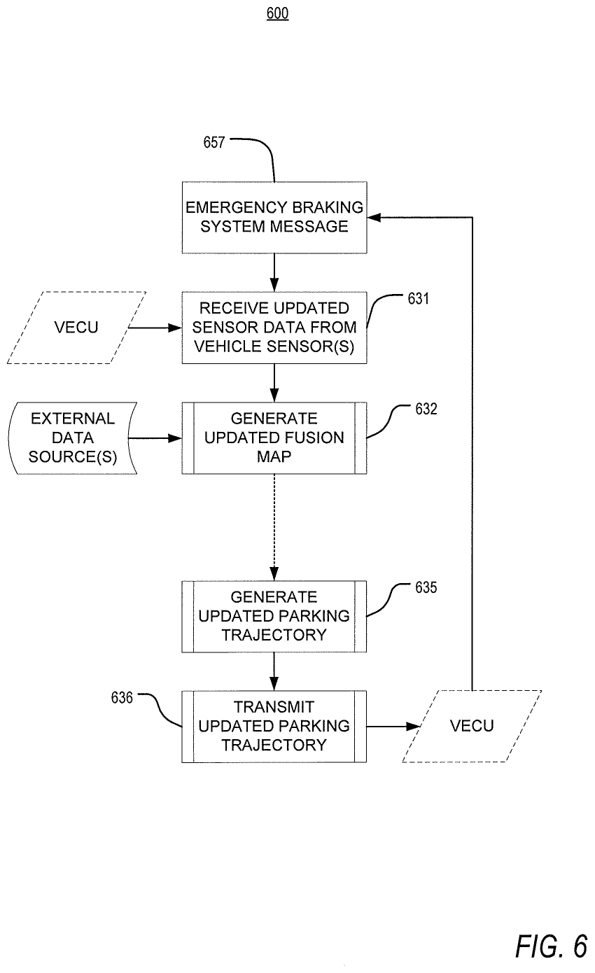

During execution of the parking trajectory, however, it may occur that the vehicle comes upon an obstacle or other impediment and must take action independent of the parking server. To this end, FIG. 6 is a flow diagram describing an implementation of the methods of the present disclosure and considering an emergency braking system, wherein the vehicle is equipped with a minimal on-board emergency braking system.

As introduced with reference to FIG. 2B, at step 631 of process 600, real-time sensor data is received from one or more sensors of the vehicle via the VECU. An updated fusion map can be generated, based upon the received sensor data, at sub process 632 of process 600. The updated fusion map can be generated by combining the updated sensor data received from the one or more sensors at step 631 with data from external data sources and current positioning data (e.g., Global Navigation Satellite System data). An updated parking trajectory can be generated at step 635 of process 600 and transmitted to the vehicle, at step 636 of process 600, for execution by the vehicle via the VECU.

It may occur, however, that sensor data from, for example, an ultrasonic sensor, a camera, or the like, indicates that an emergency braking system needs to be implemented.

In an example, the emergency braking system can be implemented by the VECU when a wireless connection between the VECU of the vehicle and the parking server is broken.

In an embodiment, an emergency braking system message can be received by the parking server at step 657 of process 600. Accordingly, steps 631, 632, 635, and 636 may be repeated in order to address the issue and to update a parking trajectory.

In another example, the emergency braking system can be implemented by the parking server in response to evaluation of sensor data from the one or more sensors of the vehicle. For instance, an evaluation of sensor data from an accelerometer and/or a gyroscope may indicate that the acceleration, velocity, orientation, and direction of the vehicle may cause an accident and, though not yet perceived by the VECU, is cause for an emergency braking system event.

In one embodiment, the emergency braking system message can be transmitted to/from the VECU in relatively small data packets that can be easily handled by cellular network bandwidth and latency.

The above-described emergency braking system, or backup solution, can, in an example, directly monitor sensor data from the ultrasonic sensors of the vehicle and determine if an emergency brake is required. In the instance where the emergency braking system message is transmitted from the vehicle to the cloud-computing environment, as in step 657 of process 600, the VECU of the vehicle is capable of performing this processing independent of recognition from the parking server. In fact, the backup solution may run in the background as a redundant system, completely decoupled from the automated parking system.

According to an embodiment, and similarly to the above, the emergency braking system message 657 may be an indication that the vehicle is on a collision path with an obstacle. In certain embodiments, and in addition to updating the parking trajectory and sending the trajectory updates to the vehicle, the parking server cyclically computes the distance to collision along the parking trajectory, or path, and sends the distance to collision to the vehicle. The in-vehicle longitudinal controller uses the received distance to collision to control the parking procedure independent of the parking server defined parking trajectory, a redundancy important in hazardous conditions.

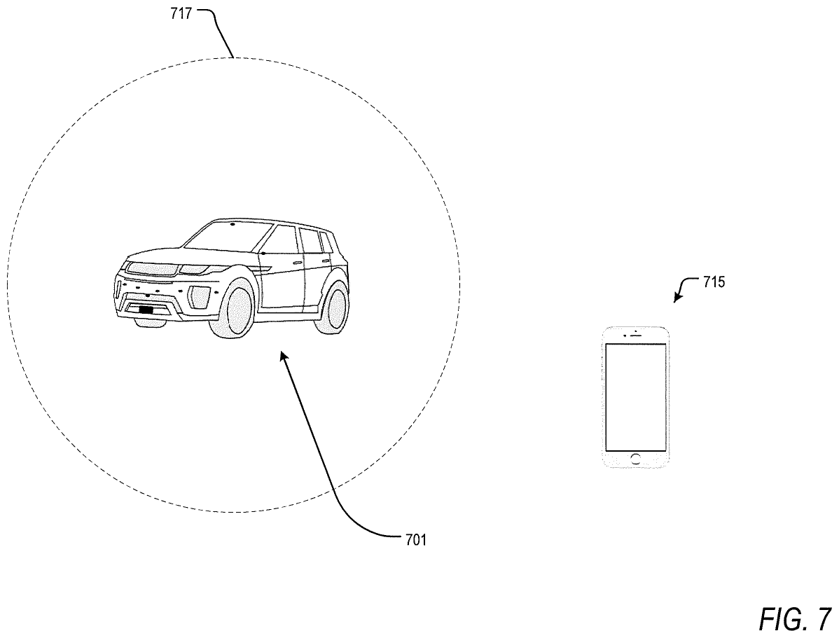

While FIG. 6 described physical safety of a driver and a vehicle during hazardous conditions, FIG. 7 provides an illustration introducing digital security measures of the CDAPS.

According to an embodiment, the parking server may confirm permissions by comparison of an identity of a vehicle 701 and an identity associated with a mobile device 715. The identity of the vehicle may be information corresponding to the vehicle 701 and stored in the parking server of a cloud-computing environment. In an example, the mobile device 715 may have a user-associated profile with the parking server and a respective vehicle may be identified based on a unique serial number.

Further to the above, and as shown in FIG. 7, the vehicle 701 may be associated with a geo-fence 717. Assuming the vehicle 701 includes a Satellite Positioning System, the geo-fence 717 may be established as a perimeter defined by a pre-determined radius extending from the vehicle, for instance, or may be a perimeter defined by any shape relative to the vehicle. In an example, and assuming the vehicle 701 includes only odometric sensors, the geo-fence 717 may be a perimeter, or footprint, of an entire parking structure in which the vehicle 701 co-localizes based on external data sources. Alternatively, the geo-fence 717 may be based on a traveled distance of the vehicle 701, determined by the odometric sensors, from an established, initial position of the vehicle 701. In an embodiment, the parking server may only accept a parking request from the mobile device 715 if the mobile device 715 co-localizes with the geo-fence 717 of the vehicle 701. In other words, the parking server may only accept the parking request when the mobile device 715 and the vehicle 701 are in close proximity to each other (e.g., the mobile device 715 is within the vehicle or is next to the vehicle). The parking server can evaluate the proximity by comparing the location of the mobile device 715 and location of the vehicle 701 based on measurements acquired from respective positioning systems. In other embodiments, the parking server may place other criteria on the location of the mobile device 715 and the vehicle 701 without departing from the teachings of the present disclosure.

According to an embodiment, the present disclosure provides technology that allows drivers to exploit modern vehicle autonomy at a fraction of the costs of a new vehicle. Instead of paying an additional $10,000 at the time of purchase, a driver of a vehicle may instead opt to purchase services as needed. For example, if a driver wishes to use the CDAPS for parallel parking, the driver may be charged, via a securely-linked account, $3 per month. If the driver wishes to be able to use the CDAPS for both parallel parking and perpendicular parking orientations, the driver may be charged $4 per month. More autonomous operations, such as ‘park me in’ and ‘park me out’, where driving outside of a parking procedure is, required, may be an additional cost per month. Notably, these automated parking options drastically reduce the costs of the vehicle while ensuring that drivers can use the features when needed. Moreover, required software stays current. For instance, instead of requiring an owner to visit a dealership for a new software upload, any updates to the CDAPS can be performed within the cloud-computing environment and immediately accessed during parking procedures. This allows for real-time software updates and, in the case of artificial intelligence-based updates, immediately improved steering and engine control.

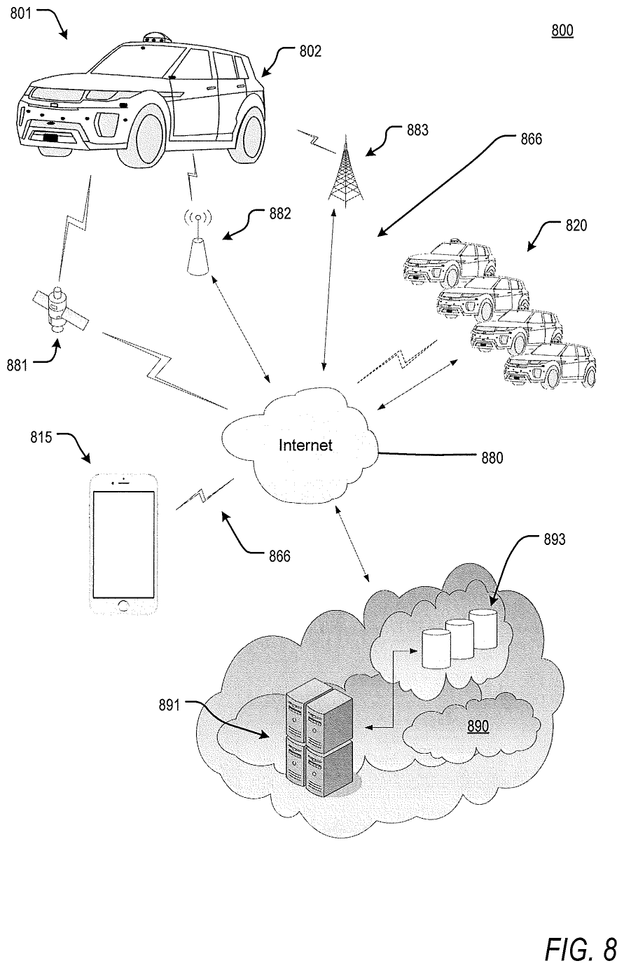

FIG. 8 illustrates an exemplary Internet-based, cloud-driven automated parking system (CDAPS), wherein a vehicle or a fleet of vehicles are connected to a cloud-computing environment via waypoints that are connected to the Internet. It will be noted that certain aspects of the following description have been described individually in previous Figures.

According to an embodiment, a vehicle 801 having a vehicle electronics control unit (VECU) 802 can connect to the Internet 880, via a wireless communication hub, through a wireless communication channel such as a base station 883 (e.g., an Edge, 3G, 4G, or LTE Network), an access point 882 (e.g., a femto cell or Wi-Fi network), or a satellite connection 881. Merely representative, each vehicle of a fleet of vehicles 820 may similarly connect to the Internet 880 in order to access CDAPS 800. In an example, longitudinal sensor data from one or more vehicle sensors of a vehicle can be stored in a data storage center 893 of a cloud-computing environment 890. Moreover, the data storage center 893 can provide storage of external data or access to external data sources, as described, with reference to FIG. 5A.

A parking server 891 can permit uploading, storing, processing, and transmitting of sensor data, and related instructions, from the data storage center 893. In an example, during an automated parking procedure, a parking trajectory may be adjusted in real-time and, accordingly, updates within the sensor data from the one or more sensors of the vehicle 801 can be used to update stored fusion maps. The parking server 891 can be a computer cluster, a data center, a main frame computer, or a server farm. In one implementation, the parking server 891 and data storage center 893 are collocated.

According to an embodiment, the vehicle 801 may connect to the parking server 891 via TCP/IP and the Internet 880. The vehicle 801 may authenticate toward the parking server 891 with a unique vehicle identifier and/or MAC address of the connectivity device. The authentication mechanism can be performed via known techniques including but not limited to SSL. The vehicle 801, accordingly, can be assigned and registered to a specific user account. In an example, the specific user account can be associated with a mobile device 815. The user, via the mobile device 815, must also authenticate on the parking server 891. Cross-authentication of the mobile device 815 and the vehicle 801 provides a unique link between the mobile device 815 and the vehicle 801 through the cloud-computing environment 890.

In an embodiment, raw and/or processed data from one or more sensors of a vehicle 801 can be transmitted to the cloud-computing environment 890 for processing by the parking server 891 and/or storage in the data storage center 893.

According to an embodiment, the parking server interfaces with the mobile device to provide optional detected parking space and to select one of the detected parking space. Additionally, though independently, the parking server provides instructions to the vehicle that includes, for example, a parking trajectory corresponding to the selected detected parking space. In executing the parking trajectory, the vehicle requires appropriate circuitry and related components.

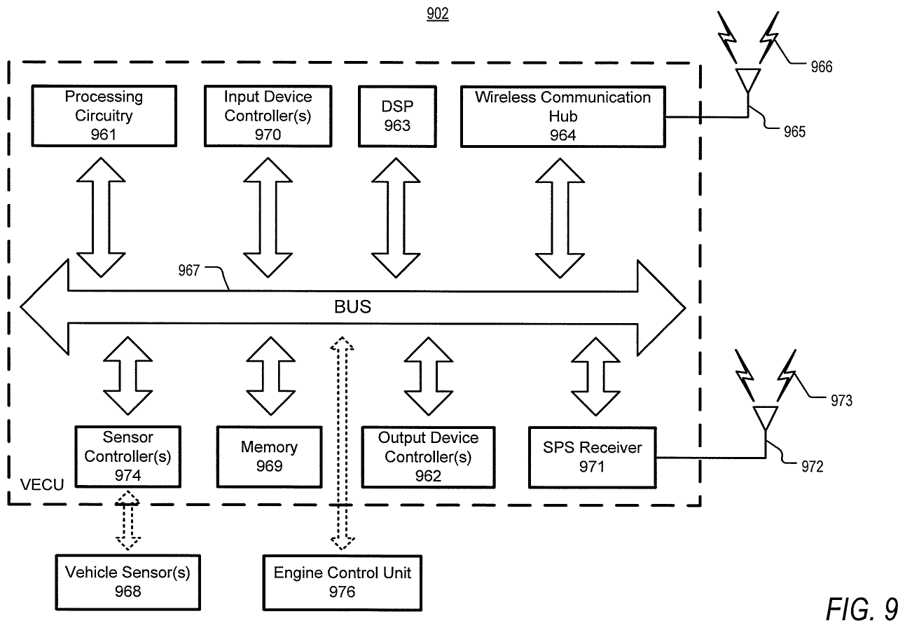

FIG. 9 is a block diagram of internal components of an exemplary embodiment of a vehicle electronics control unit (VECU) that may be implemented. As discussed above, the VECU may be an electronics control unit (ECU). For instance, VECU 902 may represent an implementation of a telematics and GPS ECU or a video ECU. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations.

The VECU 902 is shown comprising hardware elements that can be electrically coupled via a BUS 967 (or may otherwise be in communication, as appropriate). The hardware elements may include processing circuitry 961 which can include without limitation one or more processors, one or more special-purpose processors (such as digital signal processing (DSP) chips, graphics acceleration processors, application specific integrated circuits (ASICs), and/or the like), and/or other processing structure or means. The above-described processors can be specially-programmed to perform operations including, among others, image processing and data processing. Some embodiments may have a separate DSP 963, depending on desired functionality. The VECU 902 also can include one or more input device controllers 970, which can control without limitation an in-vehicle touch screen, a touch pad, microphone, button(s), dial(s), switch(es), and/or the like. In an embodiment, a mobile device as described above can be implemented within an ‘in-vehicle touch screen’.

According to an embodiment, the VECU 902 can also include one or more output device controllers 962, which can control without limitation a display, light emitting diode (LED), speakers, and/or the like.

The VECU 902 may also, include a wireless communication hub 964, or connectivity hub, which can include without limitation a modem, a network card, an infrared communication device, a wireless communication device, and/or a chipset (such as a Bluetooth device, an IEEE 802.11 device, an IEEE 802.16.4 device, a WiFi device, a WiMax device, cellular communication facilities including 4G, 5G, etc.), and/or the like. The wireless communication hub 964 may permit data to be exchanged with, as described, in part, with reference to FIG. 8, a network, wireless access points, other computer systems, and/or any other electronic devices described herein. The communication can be carried out via one or more wireless communication antenna(s) 965 that send and/or receive wireless signals 966.

Depending on desired functionality, the wireless communication hub 964 can include separate transceivers to communicate with base transceiver stations (e.g., base stations of a cellular network) and/or access point(s). These different data networks can include various network types. Additionally, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a WiMax (IEEE 802.16), and so on. A CDMA network may implement one or more radio access technologies (RATs) such as cdma2000. Wideband-CDMA (W-CDMA), and so on. Cdma2000 includes IS-95, IS-2000, and/or IS-856 standards. A TDMA network may implement Global System for Mobile Communications (GSM). Digital Advanced Mobile Phone System (D-AMPS), or some other RAT. An OFDMA network may employ LTE, LTE Advanced, and so on, including 4G and 5G technologies.

According to an embodiment, the VECU 902 may include an engine controller and can be configured to control an engine control unit 976 of the vehicle. Accordingly, in response to instructions received via the wireless communications hub 964, the engine control unit 976 can be operated in order to control the movement of the vehicle during, for example, a parking, procedure.

The VECU 902 can further include sensor controller(s) 974. Such controllers can control, without limitation, the one or more sensors 968 of the vehicle, including, among others, one or more accelerometer(s), gyroscope(s), camera(s), radar(s), LiDAR(s), odometric sensor(s), and ultrasonic sensor(s), as well as magnetometer(s), altimeter(s), microphone(s), proximity sensor(s), light sensor(s), and the like.

Embodiments of the VECU 902 may also include a Satellite Positioning System (SPS) receiver 971 capable of receiving signals 973 from one or more SPS satellites using an SPS antenna 972. The SPS receiver 971 can extract a position of the device, using conventional techniques, from satellites of an SPS system, such as a global navigation satellite system (GNSS) (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, the SPS receiver 971 can be used by various augmentation systems (e.g. an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The VECU 902 may further include and/or be in communication with a memory 969. The memory 969 can include, without limitation, local and/or network accessible storage, a disk drive, a drive array, an optical storage device, a solid-state storage device, such as a random access memory (“RAM”), and/or a read-only memory (“ROW”), which can be programmable, flash-updateable and/or the like. Such storage devices may be configured to implement any appropriate data stores, including without limitation, various file systems, database structures, and/or the like.

The memory 969 of the VECU 902 also can comprise software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods, thereby resulting in a special-purpose computer.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

According to an embodiment, the cloud-driven automated parking system of the present disclosure shifts computationally-expensive aspects of parking procedure intelligence to a cloud-computing environment and, in doing so, provides the following advantages over known systems in the art: 1) reduces processing requirements of onboard electronics control units; 2) enables the possibility to use more advanced algorithms (i.e. artificial intelligence) for low speed parking procedures as computational power, when compared with previous approaches, is not limited by a cloud-computing environment; 3) enables new opportunities such as “Pay Per Use” or “Software as a Service”, as original equipment manufacturers or service providers can simply “enable” features when desired by customers; 4) enables simple and continuous software updates in the parking server, an improvement over traditional software pushes over the air or dealer-driven updates to the electronics control unit; 5) enables new functions and features such as valet parking, remote fleet parking, and the like; 6) eliminates the need for direct phone to vehicle connectivity via Bluetooth or other radiofrequency means as phone control of the vehicle is via accessing a web address and the parking server; 7) eliminates the need for cell phone apps as mobile devices access a web address via available browsers; and 8) provides easy and unique matching of vehicles and mobile devices for multiple users to access vehicles and perform procedures.

With reference to the appended Figures, components that can include memory can include non-transitory machine-readable media. The term “machine-readable medium” and “computer-readable medium” as used herein, refer to my storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Obviously, numerous modifications and variations are possible in light of the above teachings. It is therefore to be understood that within the scope of the appended claims, the invention may be practiced otherwise than as specifically described herein.

Embodiments of the present disclosure may also be as set forth in the following parentheticals.

(1) A parking server, comprising processing circuitry configured to receive a parking request from a mobile device associated with a vehicle, receive sensor data from one or more sensors of the vehicle, generate a fusion map based at least on the sensor data from the one or more sensors, detect one or more parking spaces within a pre-defined distance from the vehicle based on the fusion map, receive, from the mobile device, a selection of one of the detected parking spaces in response to sending information corresponding to the detected parking spaces to the mobile device, generate a parking trajectory corresponding to the selected parking space, and transmit, to the vehicle, the parking trajectory, the transmission enabling an automated parking procedure by the vehicle.

(2) The parking server of (1), wherein the processing circuitry is configured to receive updated sensor data from the one or more sensors of the vehicle during the automated parking procedure, update the parking trajectory based on the updated sensor data, and transmit the updated parking trajectory to the vehicle.

(3) The parking server of either (1) or (2), wherein the processing circuitry is configured to generate the fusion map by integrating the sensor data with location information of the vehicle, the location information of the vehicle being based on odometric sensor data of the vehicle.

(4) The parking server of any of (1) to (3), wherein the sensor data is pre-processed by the vehicle prior to transmission to the parking server.

(5) The parking server of any of (1) to (4), wherein the processing circuitry is configured to determine, when the parking request is received from the mobile device, whether the mobile device is within a pre-determined distance of the vehicle, and transmit, in response to determining that the mobile device is not within the pre-determined distance of the vehicle, a notification to the mobile device indicating that the parking request will not be processed.

(6) The parking server of any of (1) to (5), wherein the one or more sensors comprise one or more of ultrasonic, lidar, radar, accelerometer, gyroscope, odometric sensor, and camera.

(7) The parking server of any of (1) to (6), wherein the processing circuitry is configured to receive a message from the vehicle indicating that an emergency braking system was activated to avoid an obstacle, and update the parking trajectory based on the received message.

(8) The parking server of any of (1) to (7), wherein the parking server interacts with the mobile device through an internet-based webpage.

(9) A method of a parking server, comprising receiving, by processing circuitry, a parking request from a mobile device associated with a vehicle, receiving, by the processing circuitry, sensor data from one or more sensors of the vehicle, generating, by the processing circuitry, a fusion map based at least on the sensor data from the one or more sensors, detecting, by the processing circuitry, one or more parking spaces within a pre-defined distance from the vehicle based on the fusion map, receiving, by the processing circuitry and from the mobile device, a selection of one of the detected parking spaces in response to sending information corresponding to the detected parking spaces to the mobile device, generating, by the processing circuitry, a parking trajectory corresponding to the selected parking space, and transmitting, by the processing circuitry and to the vehicle, the parking trajectory, the transmission enabling an automated parking procedure by the vehicle.

(10) The method of (9), further comprising receiving, by the processing circuitry, updated sensor data from the one or more sensors of the vehicle during the automated parking procedure, updating, by the processing circuitry, the parking trajectory based on the updated sensor data, and transmitting, by the processing circuitry, the updated parking trajectory to the vehicle.

(11) The method of either (9) or (10), further comprising generating, by the processing circuitry, the fusion map by integrating the sensor data with location information of the vehicle, the location information of the vehicle being based on odometric sensor data of the vehicle.

(12) The method of any of (9) to (11), wherein the sensor data is pre-processed by the vehicle prior to transmission to the parking server.

(13) The method of any of (9) to (12), further comprising determining, by the processing circuitry and when the parking request is received from the mobile device, whether the mobile device is within a pre-determined distance of the vehicle, and transmitting, by the processing circuitry and in response to the determining that the mobile device is not within the pre-determined distance of the vehicle, a notification, to the mobile device indicating that the parking request will not be processed.

(14) The method of any of (9) to (13), wherein the one or more sensors comprise one or more of ultrasonic, lidar, radar, accelerometer, gyroscope, odometric sensor, and camera.

(15) The method of any of (9) to (14), further comprising receiving, by the processing circuitry, a message from the vehicle indicating that an emergency braking system was activated to avoid an obstacle, and updating, by the processing circuitry, the parking trajectory based on the received message.

(16) The method of any of (9) to (15), wherein the parking server interacts with the mobile through an internet-based webpage.

(17) A non-transitory computer-readable storage medium storing computer-readable instructions that, when executed by a computer, cause the computer to perform a method, the method comprising receiving a parking request from a mobile device associated with a vehicle, receiving sensor data from one or more sensors of the vehicle, generating a fusion map based at least on the sensor data from the one or more sensors, detecting one or more parking spaces within a pre-defined distance from the vehicle based on the fusion map, receiving, from the mobile device, a selection of one of the detected parking spaces in response to sending information corresponding to the detected parking spaces to the mobile device, generating a parking trajectory corresponding to the selected parking space, and transmitting, to the vehicle, the parking trajectory, the transmission enabling an automated parking procedure by the vehicle.

(18) The method of (17), further comprising receiving updated sensor data from the one or more sensors of the vehicle during the automated parking procedure, updating the parking trajectory based on the updated sensor data, and transmitting the updated parking trajectory to the vehicle.

(19) The method of either (17) or (18), further comprising generating the fusion map by integrating the sensor data with location information of the vehicle, the location information of the vehicle being based on odometric sensor data of the vehicle.

(20) The method of any of (17) to (19), wherein the sensor data is pre-processed by the vehicle prior to transmission to the parking server.

(21) The method of any of (17) to (20), further comprising determining, when the parking request is received from the mobile device, whether the mobile device is within a pre-determined distance of the vehicle, and transmitting, in response to the determining that the mobile device is not within the pre-determined distance of the vehicle, a notification to the mobile device indicating that the parking request will not be processed.

(22) The method of any of (17) to (21), wherein the one or more sensors comprise one or more of ultrasonic, lidar, radar, accelerometer, gyroscope, odometric sensor, and camera.

(23) The method of any of (17) to (22), further comprising receiving a message from the vehicle indicating that an emergency braking system was activated to avoid an obstacle, and updating the parking trajectory based on the received message.

(24) The method of any of (17) to (23), wherein the parking server interacts with the mobile through an internee-based webpage.

(25) The parking server of any of (1) to (8), wherein the one or more sensors of the vehicle are a plurality of sensors, and sensor data from each of the plurality of sensors are assigned weights based upon a confidence level of a corresponding sensor.

(26) The parking server of any of (1) to (8) and (25), wherein the processing circuitry is configured to calculate a collision distance based on the updated sensor data.

(27) The parking server of any of (1) to (8) and (25) to (26), wherein the parking trajectory corresponding to the selected parking space includes a vehicle orientation relative thereto.

(28) The parking server of any of (1) to (8) and (25) to (27), wherein the processing circuitry is configured to receive the sensor data from the one or more sensors automatically when a speed of the vehicle is below a pre-determined threshold.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A parking server, comprising:
processing circuitry configured to
receive a parking request from a mobile device associated with a vehicle,
receive sensor data from one or more sensors of the vehicle,
generate a fusion map based at least on the sensor data from the one or more sensors,
detect one or more parking spaces within a pre-defined distance from the vehicle based on the fusion map,
receive, from the mobile device, a selection of one of the detected parking spaces in response to sending information corresponding to the detected parking spaces to the mobile device,
generate a parking trajectory corresponding to the selected parking space, and
transmit, to the vehicle, the parking trajectory, the transmission enabling an automated parking procedure by the vehicle.

2. The parking server of claim 1, wherein the processing circuitry is configured to
receive updated sensor data from the one or more sensors of the vehicle during the automated parking procedure,
update the parking trajectory based on the updated sensor data, and
transmit the updated parking trajectory to the vehicle.

3. The parking server of claim 1, wherein the processing circuitry is configured to
generate the fusion map by merging the sensor data with location information of the vehicle, the location information of the vehicle being based on odometric sensor data of the vehicle.

4. The parking server of claim 1, wherein the sensor data is pre-processed by the vehicle prior to transmission to the parking server.

5. The parking server of claim 1, wherein the processing circuitry is configured to
determine, when the parking request is received from the mobile device, whether the mobile device is within a pre-determined distance of the vehicle, and
transmit, in response to determining that the mobile device is not within the pre-determined distance of the vehicle, a notification to the mobile device indicating that the parking request will not be processed.

6. The parking server of claim 1, wherein the one or more sensors comprise one or more of ultrasonic, lidar, radar, accelerometer, gyroscope, odometric sensor, and camera.

7. The parking server of claim 2, wherein the processing circuitry is configured to
receive a message from the vehicle indicating that an emergency braking system was activated to avoid an, obstacle, and
update the parking trajectory based on the received message.

8. The parking server of claim 1, wherein the parking server interacts with the mobile device through an internet-based webpage.

9. A method of a parking server, comprising:
receiving, by processing circuitry, a parking request from a mobile device associated with a vehicle;
receiving, by the processing circuitry, sensor data from one or more sensors of the vehicle;
generating, by the processing circuitry, a fusion map based at least on the sensor data from the one or more sensors;
detecting, by the processing circuitry, one or more parking spaces within a pre-defined distance from the vehicle based on the fusion map;
receiving, by the processing circuitry and from the mobile device, a selection of one of the detected parking spaces in response to sending information corresponding to the detected parking spaces to the mobile device;
generating, by the processing circuitry, a parking trajectory corresponding to the selected parking space; and
transmitting, by the processing circuitry and to the vehicle, the parking trajectory, the transmission enabling an automated parking procedure by the vehicle.

10. The method of claim 9, further comprising
receiving, by the processing circuitry, updated sensor data from the one or more sensors of the vehicle during the automated parking procedure,
updating, by the processing circuitry, the parking trajectory based on the updated sensor data, and
transmitting, by the processing circuitry, the updated parking trajectory to the vehicle.

11. The method of claim 9, further comprising
generating, by the processing circuitry, the fusion map by integrating the sensor data with location information of the vehicle, the location information of the vehicle being based on odometric sensor data of the vehicle.

12. The method of claim 9, wherein the sensor data is pre-processed by the vehicle prior to transmission to the parking server.

13. The method of claim 9, further comprising
determining, by the processing circuitry and when the parking request is received from the mobile device, whether the mobile device is within, a pre-determined distance of the vehicle, and
transmitting, by the processing circuitry and in response to the determining that the mobile device is not within the pre-determined distance of the vehicle, a notification to the mobile device indicating that the parking request will not be processed.

14. The method of claim 9, wherein the one or more sensors comprise one or more of ultrasonic, lidar, radar, accelerometer, gyroscope, odometric sensor, and camera.

15. The method of claim 10, further comprising
receiving, by the processing circuitry, a message from the vehicle indicating that an emergency braking system was activated to avoid an obstacle, and
updating, by the processing circuitry, the parking trajectory based on the received message.

16. The method of claim 9, wherein the parking server interacts with the mobile through an internet-based webpage.

17. A non-transitory computer-readable storage medium storing computer-readable instructions that, when executed by a computer, cause the computer to perform a method, the method comprising:.
receiving a parking request from a mobile device associated with a vehicle;
receiving sensor data from one or more sensors of the vehicle;
generating a fusion map based at least on the sensor data from the one or more sensors;
detecting one or more parking spaces within a pre-defined distance from the vehicle based on the fusion map;
receiving, from the mobile device, a selection of one of the detected parking spaces in response to sending information corresponding to the detected parking spaces to the mobile device:
generating a parking trajectory corresponding to the selected parking space; and
transmitting, to the vehicle, the parking trajectory, the transmission enabling an automated parking procedure by the vehicle.

18. The method of claim 17, further comprising
receiving updated sensor data from the one or more sensors of the vehicle during the automated parking procedure,
updating the parking trajectory based on the updated sensor data, and
transmitting the updated parking trajectory to the vehicle.

19. The method of claim 17, further comprising
generating the fusion map by integrating the sensor data with location information of the vehicle, the location information of the vehicle being based on odometric sensor data of the vehicle.

20. The method of claim 17, further comprising
determining, when the parking request is received from the mobile device, whether the mobile device is within a pre-determined distance of the vehicle, and
transmitting, in response to the determining that the mobile device is not within the pre-determined distance of the vehicle, a notification to the mobile device indicating that the parking request will not be processed.
